(19) United States
(12) Patent Application Publication
(10) Pub. No.: US 2014/0207704 A1
(43) Pub. Date: Jul. 24, 2014

(54) METHOD FOR DETERMINING A CRIME DETERENT FACTOR

(71) Applicant: SMARTWATER LIMITED, London (GB)

(72) Inventor: Philip A. Cleary, London (GB)

(73) Assignee: SMARTWATER LIMITED, London (GB)

(21) Appl. No.: 14/158,171

(22) Filed: Jan. 17, 2014

Related U.S. Application Data
(60) Provisional application No. 61/754,154, filed on Jan. 18, 2013.

(51) Int. Cl. G06Q 30/00

(52) U.S. Cl. CPC G06Q 30/018
USPC 705/347

(57) ABSTRACT

A method for determining a crime deterrent factor of a security system or security equipment includes determining a value for a traceability factor, a robustness factor, an analytics factor, a prosecutions factor and a publicity factor based on attributes of a particular security system or security equipment, wherein the value for each of the factors is determined by comparing the attributes of the particular security system or security equipment against a scale of predetermined attributes each of which have been assigned a value; (i) factoring the traceability value by the robustness value; (ii) factoring the analytics value by the prosecution value; (iii) combining the values obtained by steps (i) and (ii) by either addition or multiplication; and (iv) multiplying the value of step (iii) by the publicity value.

### RELATED APPLICATIONS

This application is a continuation of U.S. Provisional Patent Application No. 61/754,154 filed Jan. 18, 2013, the entire content of which is incorporated herein by reference.

### FIELD OF THE DISCLOSURE

The present disclosure relates to a method of developing a sustainable crime deterrent. More particularly, the present disclosure relates to a method of quantifying the effectiveness of particular types of security systems and/or security equipment.

### DETAILED DESCRIPTION

In recent years the number of crimes, particularly thefts and robberies, have steadily increased year on year. These crimes are particularly costly for the party suffering the loss, not only due to the value loss of the goods themselves, but often these crimes lead to the disruption of business and/or infrastructure issues which can cause losses which can be orders of magnitudes higher. There is therefore a need to prevent or at least reduce the level of such theft.

Various types of security systems and equipment have been developed to combat the increasing crime rates. Unfortunately, although some systems and equipment are often alleged to be an effective crime deterrent, there is no way of quantifying how effective the systems/equipment actually are. Furthermore, there is not currently a way of appropriately comparing the crime deterrent factor of various security systems and/or equipment in order to determine which system provides a superior product.

Therefore, there is a need for a method of determining the crime deterrent factor for a particular security system or security equipment.

The present disclosure relates to a method of determining a crime deterrent factor for a particular type of security system or security equipment. Particularly, the method includes associating a value in to each of the following factors: traceability, robustness, analytics, prosecutions, and publicity. The method also includes linking the values in such a way as to provide a deference factor/value. The value associated with each of these factors is determined by selecting a value from a scale of values, wherein each value on the scale of values is associated with predetermined criteria. The value associated with each factor is preferably chosen from a scale of 0 to 3 or 4 wherein the determined value is dependent upon the attendant facts. The particular value associated with each factor and the scale will be explained in more detail below.

To determine the overall crime deterrent factor, the method further includes applying the values obtained in the following relationship:

(T^{r}+A^{p})×P=D

or

(T^{r}×A^{p})×P=D

or

((T×r)×(A×p))×P=D

wherein,
T=traceability value (the degree of traceability and its value in terms of evidence in a criminal prosecution);
r=robustness value (the natural fade rate of the system of identification and the quality of administration and manufacture measured by 1SO9001 accreditation);
A=Analytics value (identifying and narrowing the area of operation by way of professional crime pattern analysis);
p=prosecutions value (a measure of the degree of the acceptability of the evidence to the different levels of Criminal Courts);
P=publicity value (a means of education both the criminal fraternity and the law enforcement community of the existence of traceability); and
D=crime deterrent value.

Additionally or alternatively, the method can further include applying the values associated with each of the factors in the following manner: (i) factoring the traceability value by the robustness value, (ii) factoring the analytics value by the prosecution value, (iii) combining the values obtained by steps (i) and (ii) by either addition or multiplication and then (iv) multiplying the value of step (iii) by the publicity value. The method steps produce an overall value for the crime deterrent factor.

The use of this method provides a strategy that creates a powerful deterrent. The method can be used in association with a particular product and can be used as a marketing tool for a particular product by highlighting that a particularly high deterrent factor is associated with the product. This is because, where the overall crime deterrent factor is high, the product will be viewed as a particularly effective product in deterring crime.

Therefore, this method, and the value obtained therefrom, can be used to build a strong brand that will be readily recognisable by the criminal fraternity. The criminal fraternity will appreciate that there will be a real threat to their liability where the crime deterrent factor is high and will be deflected away from committing the crime where such systems or equipment is being used.

Further, the present disclosure can also be used when developing a sustainable crime deterrent. By implementing the method detailed above on formulation of the security system or security equipment, developers can attempt to improve or enhance the security system or equipment with a view of increasing the overall crime deterrent value.

This crime deterrent factor can be made available to law enforcement agencies and corporate security executives for operation in particular communities. The aim of standardizing the scale for determining the overall crime deterrent factor is for security professionals and law enforcement officers to know which security system or equipment has the highest crime deterrent value when considering the purchase and employment of a variety of systems.

Furthermore, the respective value for a crime deterrent value can be applicable generally or may be classified in respect of a particular towns, cities or regions depending on the particular effectiveness of the security system or equipment for the particular area. Additionally or alternatively, the crime deterrent value can also be applicable with respect to a particular business type or industry depending on the particular effectiveness of the security system or equipment for the particular purpose.

### Traceability

Traceability is a factor considered to relate to the traceability of a suspect or an ability of law enforcers to identify an ownership of suspected stolen property. The importance of this factor is an ability to unquestionably link the suspect to the stolen property, which is one of the cornerstone requirements of any justice system. Traceability of suspects can take many forms, such as use of CCTV footage, fingerprints or DNA evidence. It is a key component of the method of the present disclosure; without traceability, the criminal cannot be held to account and the resultant deterrent impact or factor would be decreased significantly.

The value attached to the degree of traceability will be determined by operational characteristics of a security system and evidence captured by the security system; e.g. if the burglar is videoed getting into his motor vehicle and both the image of his face and licence plate are clear, that would attract a high traceability score. However, if only part of a smudged fingerprint is all police can find or identify, a relative low score would be recorded. The absence of any traceability renders the deterrent value to be relatively low.

A specific definition of traceability is that a system used must provide guaranteed uniqueness, e.g. a forensic code at a unique location and which unquestionably links a criminal to that location would achieve the highest score of nine. In terms of acceptability to the Courts, which increases the likelihood of securing a conviction, a higher score would be attributed to the system that provides direct evidence of location of owner in a secure manner e.g. via a database operating to ISO27001 as opposed to a haphazardly written notebook.

The criteria in respect of each value on the traceability scale is as follows:
T=0—No traceability provided by system
T=1—Generic traceability provided by system
T=2—Batch traceability provided by system
T=3—Owner specific traceability provided by system

Therefore, when determining the value for the traceability of a particular type of security system or equipment, a simple comparison of the attributes of the particular system or equipment can be made against the listed criteria from the scale to identify the applicable value for traceability of the system.

### Robustness

Robustness refers to both the attributes of the technology itself and the administrative systems that support it. For example, referring back to the CCTV example, if the quality of the recording of the suspect's face is particularly poor, the suspect can allege that he is not the person on the video and escape justice as a result. In relation to CCTV systems, if the formal process for changing video disks or the recording of their storage is not accurate and/or well managed, this will weaken the prosecution case.

Another example is where a DNA property marking system is used to identify property; if the DNA fades after only a couple of weeks or can be easily removed by criminals, a low score in terms of robustness is given. Similarly, if the manufacture of the DNA tracing system is not of sufficient quality (e.g. ISO9001) or there is no care taken in terms of cross contamination, again, the prosecution case will be put into jeopardy, thereby undermining any deterrent benefit.

Therefore, it is preferable that the robustness value includes consideration with respect to both the ‘toughness’ of the system (e.g. how easy is it to remove all the traceability) and the ‘administration’ (e.g. what are the ‘back office’ systems like and will they withstand the scrutiny of the Court in terms of chain of evidence). The robustness has a factorial impact on the traceability and therefore the two are linked in the relationship according to the equation provided in the claimed method.

The criteria in respect of each value on the robustness scale is as follows:
r=0—System lasts only a few days with no administrative quality control
r=1—System lasts 6 months with ISO9001
r=2—System lasts 2 years with ISO9001
r=3—System lasts 5 years with ISO9001

Therefore, when determining the value for the robustness of a particular type of security system or equipment, a simple comparison of the attributes of the particular system or equipment can be made against the listed criteria from the scale to identify the applicable value for robustness of the system.

### Analytics

The analytics value is a reference to a need for efficient use of the robust system of traceability for it to be an effective deterrent. For example, it would not be effective for a security manager to install CCTV systems in a factory where there were no security problems, particularly if they were on a limited budget. It would be normal for a manager to conduct a cost/benefit analysis before expenditure would be authorised. The more detailed the analysis is, the higher the score in respect of this factor would be.

In terms of law enforcement, focus should be on areas where the overall deterrent factor provides the most impact and this needs professional crime pattern analysis in order to highlight and determine the most efficient use of resources to have maximum impact as a deterrent. Therefore, the analytics factor takes into account whether the strategy, equipment or system is targeted precisely by use of crime pattern analysis, which can range from the use of sophisticated analytical software to local knowledge of crime patterns e.g. warehouse manager noting the location of where stock has been pilfered.

The criteria in respect of each value on the analytics scale is as follows:
A=0—No analytics
A=1—Nation specific
A=2—State specific
A=3—Town/City specific
A=4—Neighbourhood specific

Therefore, when determining the value for the analytics in respect of a particular type of security system or equipment, a simple comparison of the attributes of the particular system or equipment can be made against the listed criteria from the scale to identify the applicable value in respect of the analytics of the system.

### Prosecutions

If a robust form of traceability is, via analytics, installed into a particular location, the value of it as a deterrent is enhanced significantly if there are successful prosecutions as a result. In fact, the absence of successful prosecutions would severely undermine the robust method of traceability as a sustainable deterrent; e.g. it is unlikely to be perceived as a threat by the criminal fraternity. In contrast, a successful prosecution demonstrates that the whole system has withstood the significant interrogation that the criminal court system would apply. This factor is therefore important when considering the use of new, cutting edge technology that might not have an established track record in the criminal courts.

The impact of the prosecution value, both high and low, with the minimum value of one, therefore has an impact in respect of the deterrent power. This value will enhance the overall deterrent factor, with a successful criminal prosecution attracting the higher score, dependent further on the seriousness of the crime e.g. a conviction for armed robbery will attract more publicity than that for shoplifting. The more prosecutions are achieved, the more sustainable the deterrent. The prosecution value has a factorial impact on the analytics and therefore the two are linked according to the relationship provided in the claimed method.

The criteria in respect of each value on the prosecution scale is as follows:
p=0—No prosecutions
p=1—Prosecutions uncontested in local Courts
p=2—Prosecutions uncontested in Federal Courts
p=3—Prosecutions uncontested in local Courts
p=4—Prosecutions uncontested in Federal Courts

Therefore, when determining the value for the prosecutions of a particular type of security system or equipment, a simple comparison of the attributes of the particular system or equipment can be made against the listed criteria from the scale to identify the applicable value for prosecutions of the system.

### Publicity

Publicity (or psychological warfare) has an impact on the sustainability of a deterrent. By using a robust form of traceability, which has been targeted correctly through professional analytics, a criminal conviction should be secured. As has been previously mentioned, there would be a collateral benefit in terms of a deterrent, albeit that this may be limited to the peer group of the offender's family and/or cohort. However, the power of the deterrent would grow by a multiple, based upon the amount of effort put into publicising the successful prosecution of an offender by use of a robust form of traceability.

The format of the publicity value can vary depending upon the circumstances. For example, police working with local media/press highlighting the success of their operation and the use of the technology, would create both raised awareness of the threat of traceability and a degree of anxiety within the criminal fraternity.

This factor is intended to value the influence on the behaviour of the criminal fraternity and is preferably determined by considering the targeted use of press and media, either external to the public or internal corporate. Preferably news of the method detailed herein should be transmitted to the criminal fraternity using a medium that will ensure maximum impact. For example:
Region—a rail company announcing on TV that it intends to use a robust form of traceability to protect its metal assets;
City—the police holding a conference with local second hand dealers to announce their use of robust traceability within a certain housing estate;
Corporate—memo within payslips announcing the companies use of robust traceability to protect assets;
Covert ‘sting’ operations, utilising the system of traceability, designed to have maximum impact on the targeted offender cohort.

The deterrent impact can be further enhanced and sustained by publicising successful criminal prosecutions/dismissals. This provides evidence to the criminal fraternity that the threat of the particular system of robust traceability is real and should be avoided. The use of a particular colour, particularly yellow can enhance the deterrent impact; yellow is particularly useful as it is used in nature as a warning sign for danger and is therefore subconsciously indicative as such.

The criteria in respect of each value on the publicity scale is as follows:
P=0—No publicity
P=1—Town/City wide publicity
P=2—State wide publicity
P=3—National Publicity

Therefore, when determining the value for the publicity of a particular type of security system or equipment, a simple comparison of the attributes of the particular system or equipment can be made against the listed criteria from the scale to identify the applicable value for publicity in respect of the system.

It will be appreciated that the method described above may be implemented at least in part by the use of software. The method described above may be implemented using general purpose computer equipment or using bespoke equipment.

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Here, aspects of the methods described herein can be executed on a mobile station and on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a FRAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

A number of embodiments have been described herein. However, it will be understood by persons skilled in the art that other variants and modifications may be made without departing from the scope of the embodiments as defined in the claims appended hereto.

1. A method for determining a crime deterrent factor of a security system or security equipment, the method comprising:
determining a value for a traceability factor, a robustness factor, an analytics factor, a prosecutions factor and a publicity factor based on attributes of a particular security system or security equipment,
wherein the value for each of the factors is determined by comparing the attributes of the particular security system or security equipment against a scale of predetermined attributes each of which have been assigned a value;
(i) factoring the traceability value by the robustness value;
(ii) factoring the analytics value by the prosecution value;
(iii) combining the values obtained by steps (i) and (ii) by either addition or multiplication; and
(iv) multiplying the value of step (iii) by the publicity value.

2. A method for determining a crime deterrent factor of a security system or security equipment, the method comprising:
determining a value for a traceability factor, a robustness factor, an analytics factor, a prosecutions factor and a publicity factor based on attributes of a particular security system or security equipment;
wherein the value for each of the factors is determined by comparing the attributes of the particular security system or security equipment against a scale of predetermined attributes each of which have been assigned a value; and
wherein the relationship of each of the factors is defined as follows:
(T^{r}+A^{p})×P=D
or
(T^{r}×A^{p})×P=D
or
((T ×r)×(A×p))×P=D
wherein,
T=traceability value
r=robustness value
A=Analytics value
p=prosecutions value
P=publicity value
D=crime deterrent value

3. The method of claim 1, wherein the value of traceability relates to the ability of law enforcers to identify the ownership of suspected stolen property.

4. The method of claim 1, wherein the value of robustness relates to an assessment of both the technology relating a security system or equipment and an assessment of any administrative systems that support the security system or equipment.

5. The method of claim 1, wherein the value of analytics relates to the efficient use of a robust system of traceability.

6. The method of claim 1, wherein the value of prosecutions relates to the number of successful prosecutions in the criminal courts or equivalent.

7. The method of claim 1, wherein the value of publicity relates to the targeted use of press or media.

8. A computer readable medium having computer-readable code embodied therein for execution by a processor in a computing device causing said computer device to:
determine a value for a traceability factor, a robustness factor, an analytics factor, a prosecutions factor and a publicity factor based on attributes of a particular security system or security equipment,
wherein the value for each of the factors is determined by comparing the attributes of the particular security system or security equipment against a scale of predetermined attributes each of which have been assigned a value;
(i) factoring the traceability value by the robustness value;
(ii) factoring the analytics value by the prosecution value;
(iii) combining the values obtained by steps (i) and (ii) by either addition or multiplication; and
(iv) multiplying the value of step (iii) by the publicity value.
